(19) United States
(12) Patent Application Publication
(10) Pub. No.: US 2015/0142197 A1
(43) Pub. Date: May 21, 2015

(54) AUTOMATED IDENTIFICATION OF COMPONENTS CONNECTED IN A POWER GRID

(71) Applicant: INTELLIGENT POWER & ENERGY RESEARCH CORPORATION (IPERC), Forth Montgomery, NY (US)

(72) Inventors: Darrell D. MASSIE, Fort Montgomery, NY (US); Peter S. CURTISS, Boulder, CO (US); Michael A. MILLER, Shreveport, LA (US)

(73) Assignee: INTELLIGENT POWER & ENERGY RESEARCH CORPORATION (IPERC), Forth Montgomery, NY (US)

(21) Appl. No.: 14/083,689

(22) Filed: Nov. 19, 2013

(51) Int. Cl. G05B 15/02; H02J 3/00

(52) U.S. Cl. CPC G05B 15/02; H02J 3/00
USPC 700/295; 700/286

(57) ABSTRACT

Automated identification of components connected within a power grid is facilitated by: obtaining by one component of the power grid a request to broadcast a power-connected beacon identifying, at least in part, the one component of the power grid; and responsive to the request, automatically broadcasting by the one component the power-connected beacon into the power grid by superimposing the beacon onto an energized power line to identify that the one component is electrically connected to the power grid. In one embodiment, the power grid includes one or more stand-alone sub-grids, and the one component is a load component, or a distribution component, or a power-supply component of one stand-alone sub-grid of the power grid, and the obtaining is subsequent to a reconfiguration of the power grid, wherein one or more stand-alone sub-grids in the power grid are modified.

### CROSS-REFERENCE TO RELATED APPLICATIONS

This application is related to U.S. Pat. No. 8,350,412 B2, issued Jan. 8, 2013, and to U.S. Pat. No. 8,447,707 B2, issued May 21, 2013, both of which are hereby incorporated herein by reference in their entirety.

### FIELD OF THE INVENTION

The present invention relates generally to the field of electrical power distribution and control, and more particularly, to an automated process for facilitating identification of components connected within a power grid, such as a stand-alone sub-grid of one or more stand-alone sub-grids of the power grid.

### BACKGROUND OF THE INVENTION

In conventional power generation and distribution networks or grids, electrical power is transmitted across electrical power lines or wires. Since power flows along the path of least resistance, the transfer of electricity across the power lines of a power grid is conventionally not affiliated with a data information stream tracking the point of origin or point of use of the power.

Further, in a conventional power generation and distribution network, electrical power is typically transmitted across multiple levels of components, for instance, from power generating source components, through various distribution components to one or more power consuming or load components. While monitoring systems have been employed to monitor electricity flowing through a power generation and distribution network, and to effect operation of power consuming components based on, for instance, peak and off-peak power usage, today's networks cannot facilitate identification of the various components within or coupled to the power grid, which limits further automated control of the power grid.

### BRIEF SUMMARY

The shortcomings of the prior art are overcome and additional advantages are provided through the provision of a method which facilitates automated identification of components connected via a power grid by: obtaining by one component of the power grid a request to broadcast a power-connected beacon identifying, at least in part, the one component of the power grid; and automatically broadcasting by the one component the power-connected beacon into the power grid, the automatically broadcasting comprising superimposing the power-connected beacon onto an energized power line of the power grid to signal that the one component is electrically connected to at least a portion of the power grid.

In another aspect, a system for facilitating automated identification of components connected via a power grid is provided. The system includes: at least one memory, and at least one processor in communications with the at least one memory. The system is capable of performing a method which includes: facilitating automated identified of components connected via a power grid, the facilitating including: obtaining by one component of the power grid a request to broadcast a power-connected beacon identifying, at least in part, the one component of the power grid; and automatically broadcasting by the one component of the power grid the power-connected beacon into the power grid, the automatically broadcasting including superimposing the power-connected beacon onto an energized power line of the power grid to signal that the one component is electrically connected to at least a portion of the power grid.

In a further aspect, a computer program product is provided for facilitating automated identification of components connected via a power grid. The computer program product includes a storage medium readable by a processing circuit and storing instructions for execution by the processing circuit for performing a method which includes: facilitating automated identification of components connected via the power grid. The facilitating includes: obtaining by one component of the power grid a request to broadcast a power-connected beacon identifying, at least in part, the one component of the power grid; and automatically broadcasting by the one component the power-connected beacon into the power grid, the automatically broadcasting comprising superimposing the power-connected beacon onto an energized power line of the power grid to signal that the one component is electrically connected to at least a portion of the power grid.

Additional features and advantages are realized through the techniques of the present invention. Other embodiments and aspects of the invention are described in detail herein and are considered a part of the claimed invention.

### BRIEF DESCRIPTION OF THE SEVERAL VIEWS OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 illustrates one embodiment of a power grid configured (by way of example) as two stand-alone sub-grids, each having components with automatic identification facilities associated therewith, in accordance with one or more aspects of the present invention;

FIG. 2 illustrates one embodiment of a power-connected beacon detector/transmitter capable of being replicated for association with one or more components of a power grid or sub-grid thereof, such as illustrated in FIG. 1, in accordance with one or more aspects of the present invention;

FIG. 3 illustrates one embodiment of a power-connected beacon, without being superimposed on a background power signal, in accordance with one or more aspects of the present invention;

FIG. 4 is a graphical illustration of one embodiment of a typical voltage or current waveform of an alternating current power line onto which a power-connected beacon is to be superimposed, in accordance with one or more aspects of the present invention;

FIG. 5 is a graphical illustration of the power-connected beacon of FIG. 3 superimposed onto the waveform of FIG. 4, in accordance with one or more aspects of the present invention;

FIG. 6 illustrates graphically another example of the power-connected beacon superimposed onto a noisy, energized AC power line signal, in accordance with one or more aspects of the present invention;

FIGS. 7A & 7B depict one embodiment of a process for facilitating automated identification of components connected within a power grid or sub-grid thereof, in accordance with one or more aspects of the present invention; and

FIG. 8 depicts one embodiment of a computer program product incorporating or more aspects of the present invention.

### DETAILED DESCRIPTION

Aspects of the present invention and certain features, advantages, and details thereof, are explained more fully below with reference to the non-limiting examples illustrated in the accompanying drawings. Detailed descriptions of well-known power grid components and function are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

As used herein, “power grid” refers generally to a power generation and distribution network, and is an electrically powered grid which includes, in one embodiment, at least one stand-alone sub-grid. Each stand-alone sub-grid includes at least one power supply component, that is, at least one power source, such as a power generator, which in one example, is a portable generator. By way of specific example, the power grid may be a mobile power grid, such as a tactical power grid employed by an armed services unit. Further, each stand-alone sub-grid comprises (in one embodiment) at least one load component. The power grid may comprise an AC or DC power distribution system or architecture.

The above-referenced U.S. Pat. No. 8,350,412 B2 describes a technique for automatically controlling configuration of a power grid, which includes one or more stand-alone sub-grids. In this patent, each stand-alone sub-grid includes a power supply component (e.g., power generator), and a load component. The technique includes: monitoring the power grid by monitoring power demand of a load associated with the stand-alone sub-grid(s), and the power generated by the power supply components within each stand-alone sub-grid; automatically determining that a grid configuration change is required for the power grid based on the monitoring; and dynamically reconfiguring the power grid by automatically modifying a number of stand-alone sub-grid(s) in the power grid without interrupting power to the load associated with the stand-alone sub-grid(s) of the power grid. For instance, the monitored power grid may include multiple stand-alone sub-grids, and the dynamically reconfiguring may include automatically, electrically connecting a first stand-alone sub-grid and a second stand-alone sub-grid of the multiple stand-alone sub-grids into a single stand-alone sub-grid, and automatically deactivating at least one power supply component powering one of the first stand-alone sub-grid or the second stand-alone sub-grid, without interrupting power to the single stand-alone sub-grid.

The automatically, electrically connecting may include employing a grid connect unit, such as a distribution network switch, electrically connected to the first stand-alone sub-grid and the second stand-alone sub-grid, and automatically, electrically connecting the first stand-alone sub-grid and the second stand-alone sub-grid into the single stand-alone sub-grid when, for instance, load associated with at least one of the first or second stand-alone sub-grids is below a low-power-load threshold, wherein the grid connect unit comprises a power relay, which when closed, electrically connects the first stand-alone sub-grid and the second stand-alone sub-grid. The automatically, electrically connecting may further include monitoring voltage frequencies within the first stand-alone sub-grid and the second stand-alone sub-grid, and automatically, electrically connecting the first stand-alone sub-grid and the second stand-alone sub-grid into the single stand-alone sub-grid when the monitored voltage frequencies of the first stand-alone sub-grid and the second stand-alone sub-grid are in phase.

In another aspect, the dynamically reconfiguring of the power grid may include, without interrupting power, automatically, electrically separating a single stand-alone sub-grid of the at least one stand-alone sub-grid into a first stand-alone sub-grid and a second stand-alone sub-grid, and automatically activating a power generator (or power supply component) for one of the first stand-alone sub-grid or the second stand-alone sub-grid, without interrupting power to the first stand-alone sub-grid or the second stand-alone sub-grid. For instance, the automatically, electrically separating may include employing a grid connect unit electrically connected to the single stand-alone sub-grid, and automatically, electrically separating the single stand-alone sub-grid into the first stand-alone sub-grid and the second stand-alone sub-grid when the load associated with the single stand-alone sub-grid is above a high-power load threshold of the single stand-alone sub-grid, or the load associated with the single stand-alone sub-grid is dynamically projected to be above the high-power load threshold of the single stand-alone sub-grid. The grid connect unit may include a power relay, which when opened, in combination with the automatically activating of the power supply component, electrically separates the single stand-alone sub-grid into the first stand-alone sub-grid and the second stand-alone sub-grid.

Numerous details of implementation of the above-described dynamic control of configuration of a power grid are provided in the incorporated U.S. Pat. No. 8,350,412 B2.

The above-incorporated U.S. Pat. No. 8,447,707 B2 describes an automated, distributed control facility for a power network. In accordance with this patent's teachings, automated control is facilitated by associating intelligent power controllers (IPCs) with selected components of the power network. The IPCs are configured (e.g., programmed) to automatically associated metadata with raw data streams representative of various operational aspects of the associated components to produce self-identifying data streams. The self-identifying data streams are then used to generate predictive process models, which in turn are employed to selectively produce control signals for controlling one or more control points associated with one or more components of the power network. The control signals could cause any number of a variety of actions, for example, actions to set one or more operating levels of a component, or actions to control when one or more components turn on or off. Advantageously, power generation and utilization optimizations may be performed by one or more IPC managers to produce a set of control signals that direct power component usage and avoid undesirable or inefficient operational effects, such as power overload or fuel exhaustion. Further details of this automated, distributed control facility are provided in this incorporated U.S. Pat. No. 8,447,707 B2.

Building (in part) upon the above-summarized teachings, the present invention relates generally to the field of power generation and distribution, and more specifically, to a process for generating, transmitting, and detecting a power-connected beacon to facilitate automatically identifying components of a power grid, such as a stand-alone sub-grid of the power grid, to determine (for instance) if two or more components (e.g., pieces of equipment) are electrically connected in the power grid. Disclosed herein is a technique to communicate a data signal configured as one or more electrical pulses (i.e., the power-connected beacon) in such a way that the sending and receiving component locations are known within the power grid, and from this information, to automatically ascertain which components are electrically connected via the power grid. The technique is particularly useful in power grids where dynamic reconfiguration of the grid may occur to, for instance, combine, divide, etc. stand-alone sub-grids within the power network. The information may also be used to determine if, for instance, a grid connect unit, such as a breaker or other device, connected to an AC power line or wire, is functioning, or mechanically or electrically defective. As noted, an application of the concepts disclosed herein is automatically determining the grid configuration of a power grid that is dynamically reconfigured using, for instance, the techniques described in the above-incorporated U.S. Pat. No. 8,350,412 B2.

In order to understand the current configuration of a power grid, it is necessary to know if electrical connections exist between different components of the power grid. Specifically, it is necessary to know where individual components (e.g., power supply components, distribution components, or load components, such as heating ventilation and conditioning (HVAC), environmental control units, power distribution units, etc.) are located in relation to each other. Note that location in this context is based on electrical connection, not physical location. In particular, it is necessary to identify which components are electrically connected within the power grid or a sub-grid thereof at a given time. Since the physical connections can be modified at any time, a technique is disclosed herein for having, in one embodiment, each component broadcast its connection location on the power grid. Further, information specific to an individual component of the power grid may be transmitted within the broadcasted power-connected beacon. This information can be used to develop a smart grid identification, which can be used in offering automated power management at a level currently not possible.

Generally stated, disclosed herein is a method, system, and computer program product which implements a technique for facilitating automated identification of components connected via a power grid. The technique includes: obtaining by one component of the power grid a request to broadcast a power-connected beacon identifying, at least in part, the one component of the power grid; and automatically broadcasting by the one component the power-connected beacon into the power grid, the automatically broadcasting including superimposing the power-connected beacon onto an energized power line of the power grid to signal that the one component is electrically connected to at least a portion of the power grid.

Note that the “power-connected beacon” or “power beacon” disclosed herein is (in at least one embodiment) an electrical signal which imposes an actual change on, for instance, the current flow of an energized power line. The power-connected beacon is not a radio frequency signal or other wireless signal, but rather, is a signal (e.g., a generated pulse of energy) which modifies the current flow across the power line. Additionally, the power-connected beacon or power beacon signal disclosed herein is only communicated across an energized power line. The signal will not be communicated across an interrupted power line, such as a power line which has an open switch. These concepts are significant to understanding the benefit of the power-connected beacon and processes described herein. By determining which components of a power grid are electrically connected, the processing presented advantageously also determines which components of the electrical grid are electrically isolated from each other.

In one embodiment, the power grid includes one or more stand-alone sub-grids, each stand-alone sub-grid including at least one power supply component and at least one load component, wherein the one component is one component of the at least one power supply component and one load component of one stand-alone sub-grid of the one or more stand-alone sub-grids of the power grid. For instance, in one implementation, the component is a load component of the power grid, and the technique is employed to ascertain whether the load component is within the one stand-alone sub-grid, that is part of a particular sub-grid of the power grid.

By way of example, the obtaining may be subsequent to a reconfiguration of the power grid, wherein one or more stand-alone sub-grids of the power grid are modified by the reconfiguration. For example, the reconfiguration of the power grid may be a dynamic reconfiguration of the power grid, wherein one or more stand-alone sub-grids of the power grid are automatically modified without interrupting power to the power grid, and without shedding load components from the power grid.

In one embodiment, the one component is a load component of the one stand-alone sub-grid, and the method further includes, prior to the automatically broadcasting, obtaining by the at least one power supply component of the one stand-alone sub-grid an indication of an anticipated power-connected beacon broadcast on the energized power line of the power grid, wherein the indication facilitates detection by the at least one power supply component of the power-connected beacon broadcasted by the load component of the one stand-alone sub-grid.

In another embodiment, the one component is a load component of the one stand-alone sub-grid, and the obtaining includes receiving by the load component the request from a controller associated with the power grid, wherein the controller sequentially sends the request to broadcast the power-connected beacon to a plurality of load components coupled to the power grid, and wherein the plurality of load components include the at least one load component of the one stand-alone sub-grid.

Further, prior to the automatically broadcasting, the controller may send an indication of an anticipated power-connected beacon broadcast on the energized power line of the power grid to a plurality of power supply components coupled to the power grid. In one implementation, the controller may be associated with at least one power supply component of the power grid, and the controller may send the request subsequent to a dynamic reconfiguration of the power grid, wherein one or more stand-alone sub-grids of the power grid are automatically modified.

In another embodiment, the technique many include inquiring, by the controller, whether the at least one power supply component of the one stand-alone sub-grid received the power-connected beacon superimposed onto the energized power line of the power grid by the load component, and based in part thereon, the technique may include the controller automatically determining which components of the plurality of load components and a plurality of power supply components coupled to the power grid are electrically connected in the one stand-alone sub-grid.

In one implementation, the power-connected beacon is automatically broadcasted by the one component of the power grid responsive to obtaining or receiving by the one component the request to broadcast, and is a signal unique to the one component within the power grid. This unique signal may identify at least one attribute of the one component of the power grid. As one example, the power-connected beacon may comprise a distinct pattern of electrical pulses, wherein the automatically broadcasting includes automatically superimposing the distinct pattern of electrical pulses onto the energized power line for broadcast from the one component of the power grid as a power-connected beacon of that one component.

By way of further example, the power-connected beacon generation, transmittal, and detection disclosed herein sets out a technique for components of a power grid to announce their location within an electrically-connected portion of the power grid. In implementation, the power-connected beacon may be a series of electrical pulses, and communication software may be provided to coordinate transmittal and detection of the power beacon signal.

As described further below, one or more control processes of the automated identification facility disclosed herein may be implemented in software, or in a combination of hardware and software. These control processes may examine network interfaces and address configuration of devices within a communications network (or data network) that may be established in parallel with the power grid. The sending host, for instance, a controller, may comprise a data processor, a data acquisition board, as well as other elements described hereinbelow. The power-connected beacon may comprise short bursts of pulsed electrical current in a unique and distinct pattern, such that the pattern can be received by a power beacon detector, and positively identify that the component transmitting the power beacon is electrically connected to the component receiving the power beacon within the power grid.

Reference is made below to the drawings, which are not drawn to scale for ease of understanding, wherein the same reference numbers throughout different figures designate the same or similar components.

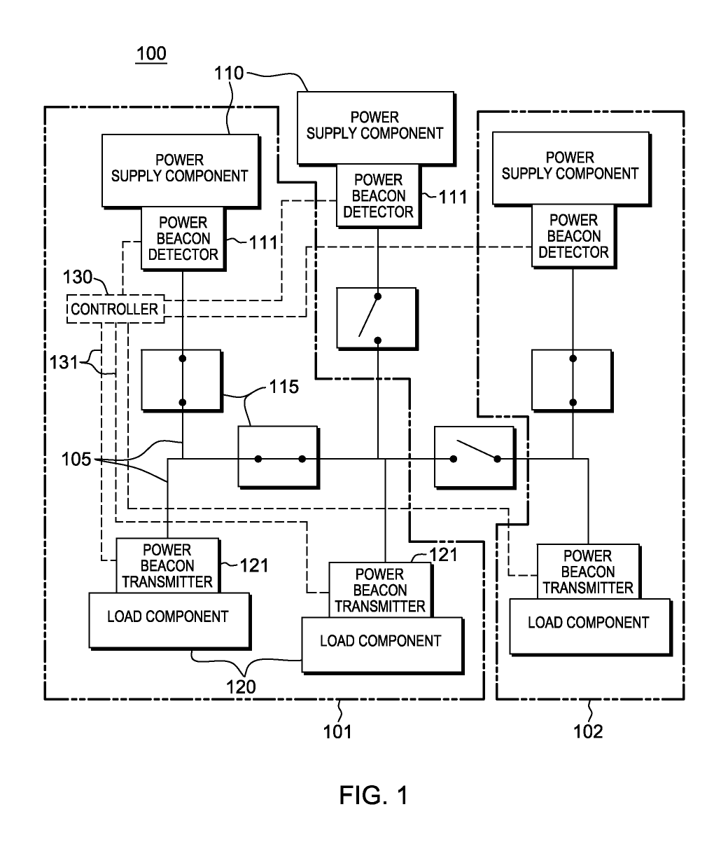

FIG. 1 depicts one embodiment of a power grid, generally denoted 100, which comprises (by way of example only) multiple stand-alone sub-grid, including stand-alone sub-grid 101 and stand-alone sub-grid 102. As shown, power grid 100 includes a plurality of power supply components 110, a plurality of power distribution components 115, and a plurality of load components 120, interconnected by power lines 105. Each sub-grid 101, 102 includes (in this example) at least one power supply component 110 and one or more load components 120. As noted above, each power supply component 110 may comprise a power source, such as a power generator. In one specific example, the power generator may comprise a mobile power generator, and the power grid, one example of a tactical power grid, although the concepts disclosed herein are not limited to a mobile, tactical power grid implementation.

Power distribution units 115 may comprise grid connect units, such as power distribution switches, breakers, etc., which facilitate, for instance, automated reconfiguration of power grid 100 into different combinations of sub-grids, such as sub-grids 101, 102. Note that each sub-grid 101, 102 is a stand-alone sub-grid, in that each sub-grid is not electrically connected to another sub-grid of the power grid, and includes its own power supply component and power-consuming (or load) component. As noted herein, subsequent to an automated dynamic reconfiguration of power grid 100, it may be desirable for the components of each sub-grid to self-identify via the power grid itself in order for (for instance) a controller 130 to ascertain which components, including power supply components, load components, as well as power distribution components 115, are electrically connected within each sub-grid of the power grid. To facilitate this self-identification, power beacon detectors 111 are associated with the power supply components 110, and power beacon transmitters 121 are associated with the load components, by way of example.

Note that in other implementations, each power beacon detector may be both a power beacon detector and transmitter, and each power beacon transmitter may be both a power beacon transmitter and detector. Note further that the power distribution units 115 may also have associated therewith a power beacon detector and/or transmitter, depending upon the implementation desired. Also, note that although controller 130 is illustrated in one example as an external controller or control system, controller 130 could be incorporated into one or more of the power grid components 110, 115, 120, for instance, in a distributed manner, such as described in the above-incorporated, U.S. Pat. Nos. 8,350,412 B2 and 8,447,707 B2. Still further, note that controller 130 could be configured and coupled to automatically control power distribution components 115, and to provide a facility for dynamic reconfiguration of power grid 100 as needed, for instance, based on load requirements and power supply capabilities.

In one embodiment, power grid 100 may be dynamically reconfigured when necessary in order to achieve greater energy efficiency, or to meet an increasing power demand. For instance, over time, individual power loads may fluctuate significantly, in which case, it may be desirable to dynamically reconfigure the sub-grids of the power grid in order to, for instance, maintain efficiency of the power supply components (e.g., generators).

The power beacon (or power-connected beacon) disclosed herein is advantageously automatically broadcasted by one or more components of the power grid in order to facilitate automated identification or discovery of the components within, for instance, a particular sub-grid of the power grid. In one embodiment, sending of the power-connected beacon is responsive to receiving or obtaining by one component of the power grid a request to broadcast the respective power-connected beacon identifying, at least in part, the one component of the power grid. For instance, the power-connected beacon may comprise a unique electrical pulse signal to be sent through, for instance, the power lines, that is, one or more of the energized power lines of the power grid. In one implementation, the power beacon signal is sent over a short period of time within a set detection window of, for instance, less than one second. Each “pulse” of a power-connected beacon may be of relatively short duration, for instance, lasting no longer than a fraction of a cycle to several cycles. Although not required, the power-connected beacon may correspond with zero crossing of the current or voltage waveform in order to minimize signal noise associated with the power line.

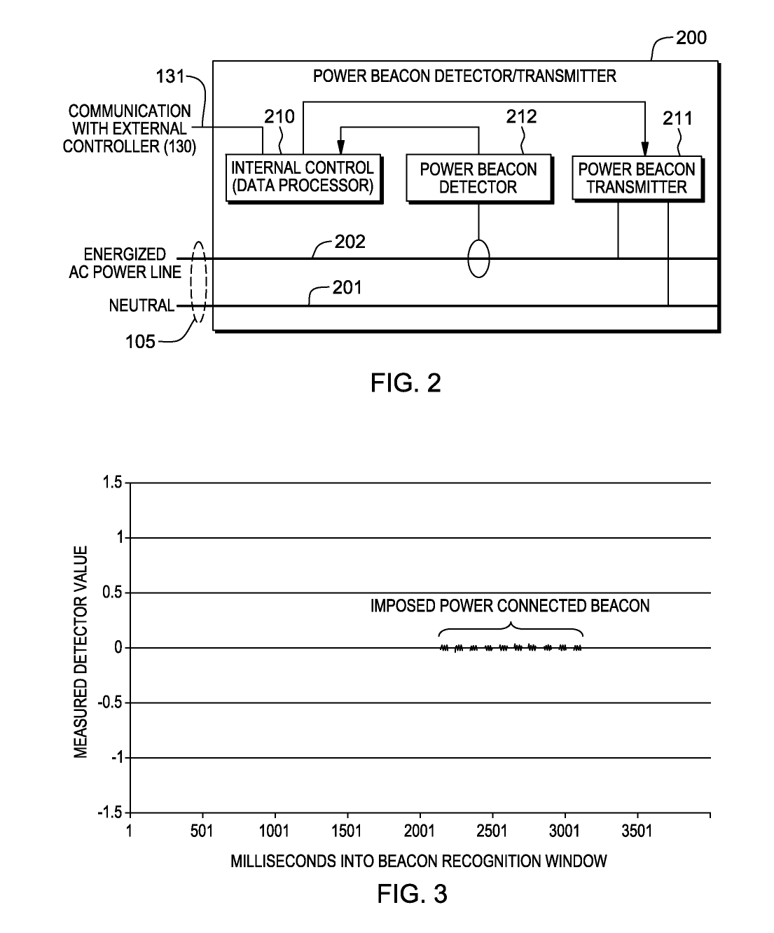

By way of example, FIG. 2 depicts one embodiment of a combined power beacon detector/transmitter 200, which includes an internal control (or data processor) 210, a power-connected beacon transmitter 211, and a power-connected beacon detector 212. Internal control 210 may be configured as, for instance, a sending host or a receiving host, or both, depending upon the desired implementation. As a transmitting host, the power-connected beacon detector/transmitter 200 transmits via power beacon transmitter 211 the power-connected beacon onto an energized power line 202, which is energized relative to a neutral line 201 of the power distribution lines 105 of the power grid. Note that (in one embodiment) controller 130 communicates via data or control lines or channels 131, such as one or more wired or wireless channels, with internal control 210 of power beacon detector/transmitter 200. These control lines or channels 131 are, for instance, separate from the power line(s) 202 across which power is transmitted within the power grid, although in one embodiment, they could comprise or utilize the neutral line 201 of the power grid. Note also that internal control 210 may include a data acquisition facility to assist with communication with external controller 130, including a communication port, such as a serial, parallel or USB port, to facilitate transfer of data between external controller 130 and internal controller 210 of the power beacon detector/transmitter 200, which in one embodiment, may be replicated and associated with multiple, or most, or all, components of the power grid, as desired.

In accordance with aspects of the present invention, an automatic facility is provided for, for instance, controller 130 to discover the current electrical connections within the power grid or the sub-grids of the power grid. This is achieved by using a unique electrical pulse or beacon that is selectively, sequentially transmitted over the AC power line(s) of the power grid. In one embodiment, the power line may be single-phase AC power line, or, for instance, a phase of a three-phase AC power line, in which case the power beacon may be transmitted on one or more of the three phases of the AC power line.

In one embodiment, the power beacon transmitter 211 may be implemented as a resistive load controlled by internal control 210 to generate a unique set of electrical pulses corresponding to the desired power-connected beacon to be broadcast by the one component onto the power line of the power grid, that is, to be superimposed onto the power line of the power grid as a signal that the one component is electrically connected to at least a portion of the power grid. This resistive load may be, for instance, a resistor, an electromechanical actuator, an electromagnetic actuator, a solid state switching device, etc., any one of which may produce a resistive load on the energized power line.

In one embodiment, note that the power beacon detector 212 may comprise, for instance, a current transducer or equivalent electrical current reading device. The current transducer measures the current in the power line, and is capable of detecting the power-connected beacon signal sent by a particular sending component of the power grid. The internal control 210 may be implemented as a high-speed data acquisition board, which may communicate a detected pattern back to external controller 130. By way of example, a pattern recognition algorithm may be employed to identify a unique beacon (e.g., pulse current signal) embedded within the total current on the power line. Such a pattern recognition algorithm may be readily implemented by one of ordinary skill in the art based on the discussion provided herein. For instance, statistical methods may be employed across a moving window to determine if the power beacon is present. The statistical methods may include running a regression analysis comparing a sequence of zeros and ones to the measured current. The purpose of the regression is to identify any statistically significant pattern matching between, for instance, a zero, one, zero, one . . . sequence, and any similar behavior of the current. Both the coefficient of correlation (i.e., the R²), and the coincident standard deviation of the current for each interval within the moving window may be determined. If both these values exceed a specific threshold, then it may be concluded that the power beacon is present.

Note that, in embodiments such as depicted in FIG. 1, separate power beacon detectors 111 and power beacon transmitters 121 may be configured. For instance, a power beacon detector could comprise an internal controller or data processor, along with a power beacon detector, such as discussed above in connection with FIG. 2, and a power beacon transmitter could comprise an internal control or data processor in combination with a power beacon transmitter such as described above in connection with the combined power beacon detector/transmitter embodiment of FIG. 2. Configuration of the transmitters and detectors may depend, in part, on whether the power supply components are also to send a power beacon during the automated identification of components connected within the power grid.

By sending and detecting the power-connected beacon over the energized AC power lines, the facility disclosed herein advantageously positively identifies that the sending and receiving components are connected to the same electrical wire, and thus, are part of the same sub-grid of the power grid. Note that, depending upon the implementation, the power-connected beacon may be the same or different for each component of the power grid. For instance, each load component may have a particular timing pattern of unique pulses or signals which identifies one or more attributes or characteristics of that component to, for instance, a power beacon detector associated with a power supply component, or other component, of the power grid. The power beacon detector 111 or power beacon detector/transmitter (FIG. 2) is configured to recognize the specific power-connected beacon, and verify, based thereon, that two or more components are electrically connected within the power grid or sub-grid.

In one implementation, the power-connected beacon is broadcasted from, for instance, a load component, and is received at all attached receiving or detector components, including (for instance) other load components or distribution components, as well as power supply components. The facility disclosed herein advantageously positively confirms if electrical current can be transferred through the identified AC power line between two or more components in a sub-grid or power grid. The unique and distinct power-connected beacon of a particular component can also be employed to dynamically build a list of components or equipment within the power grid. That is, the power-connected beacon may be used to distinguish attributes of the individual components of the power grid, in addition to the presence or absence of the electrical connection therebetween.

As noted, the power-connected beacon can be generated using a switch or pulse-width modulation, or other means. Pulse-width modulation may be employed to produce unique switching frequencies that adjust the width of the pulse based on modulation signal information. This unique and distinct beacon may be detected or read by a receiving component of the power grid. In one implementation, information or attributes pertaining to the features of the sending component may be associated with the beacon, for instance, in an analogous manner to a bar code. This information can be used to replace a direct broadcast method for, for instance, discovering IP addresses on a data network, such as via data lines 131 coupling controller 130 to the individual beacon detectors/transmitters of the components of the power grid.

By way of further example, FIG. 3 depicts one embodiment of a power-connected beacon signal superimposed onto an un-energized AC power line. As described herein, the power-connected beacon may be transmitted or superimposed onto the AC power line during a defined detection window (or beacon recognition window), within which one or more detectors are awaiting receipt of the power-connected beacon.

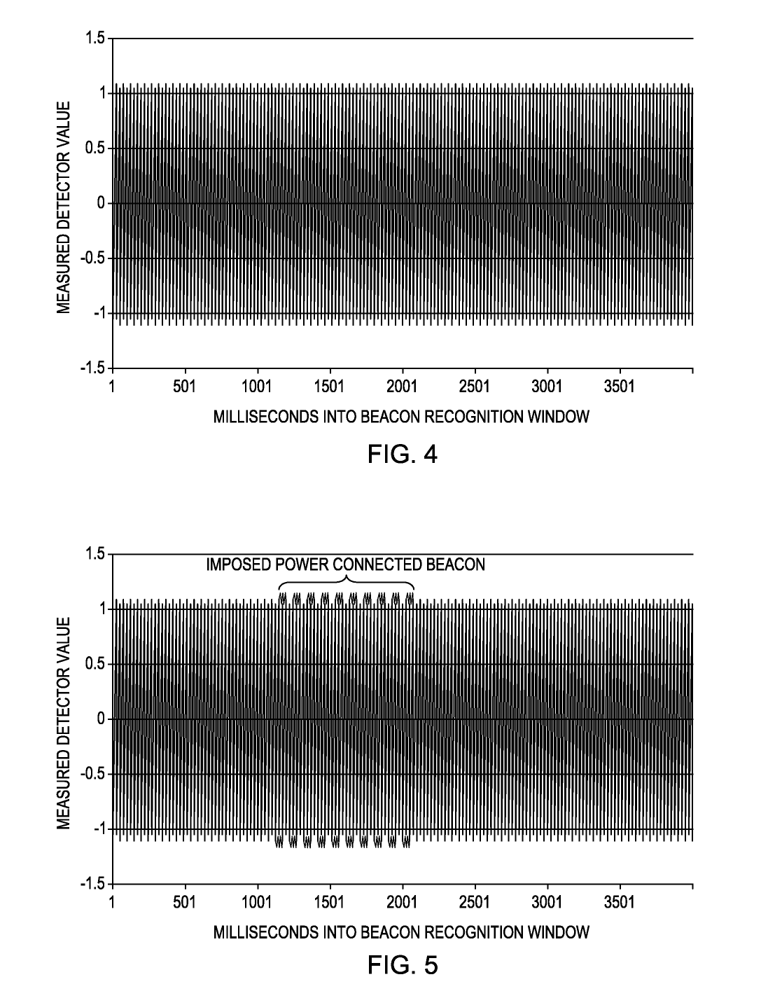

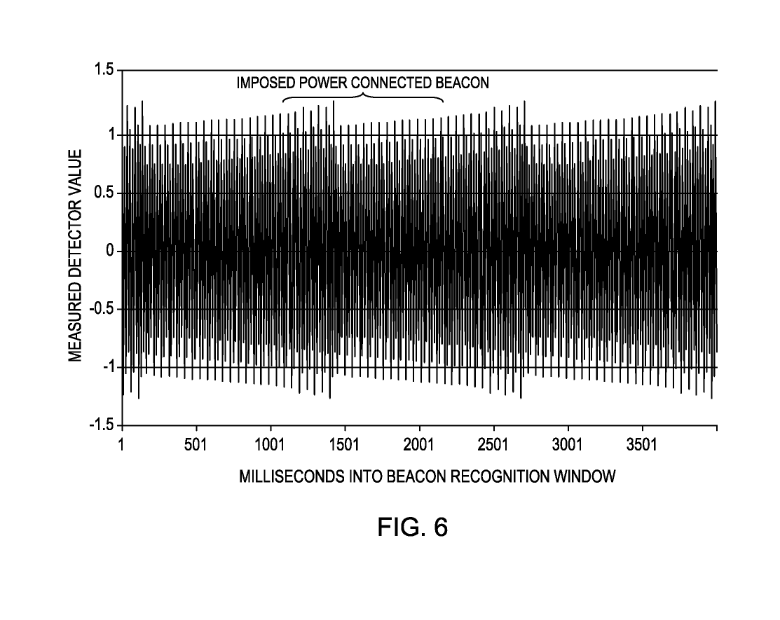

FIG. 4 is a graphical illustration of a typical voltage or current wavelength of an AC power signal, and FIG. 5 depicts the typical AC power signal of FIG. 4, with a power-connected beacon superimposed onto the AC power line within, for instance, a beacon recognition time window. As explained above, the power-connected beacon may comprise a series of electrical pulses superimposed onto the voltage or current signal, and these pulses may be of a particular configuration to relay information from the sending component to the receiving component via the energized AC power line. Note that by signaling the power beacon detectors prior to transmission of the power beacon signal, the detectors are more readily able to detect or sense the power-connected beacon signal superimposed onto the AC power line. This is particularly advantageous if there is noise associated with the voltage or current signal of the AC power line, such as depicted in FIG. 6. Again, the beacon recognition window may be a defined time period within which the power-connected beacon is to be transmitted and received. In addition, the power beacon detection approach may employ statistical methods to ascertain whether the power beacon is present, even in the presence of noise, such as depicted in FIG. 6. In the case where the power beacon is, for instance, well hidden by noise inherent in the electrical current (for instance, due to different electrical loads on the power network), the statistical method employed needs to be reliable and repeatable in deriving the power beacon signal from such a measurement with inherent noise.

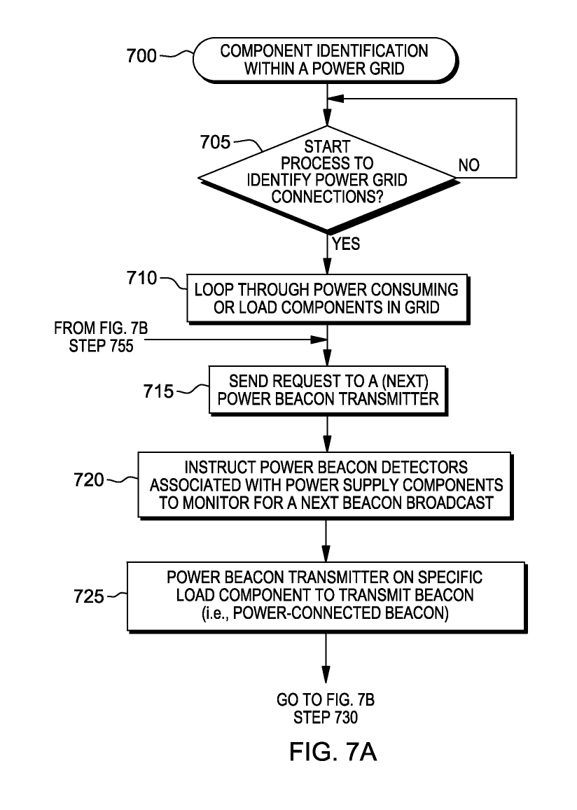

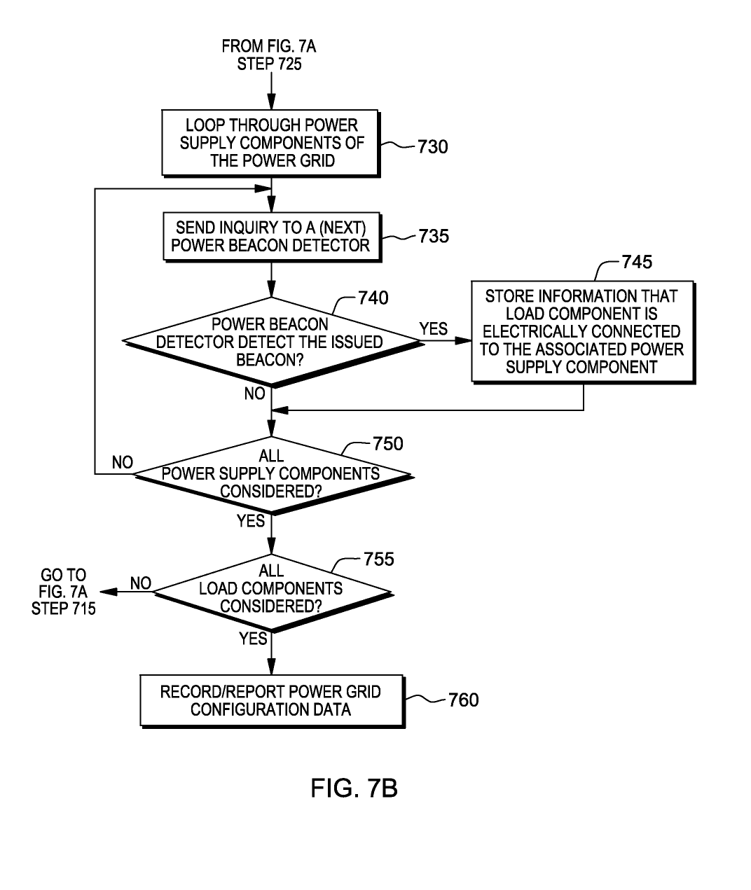

By way of further example, FIGS. 7A & 7B depict one embodiment of a process overview for automated identification of components connected via a power grid, in accordance with one or more aspects of the present invention.

As explained herein, this automated identification facility employs a power-connected beacon signal, such as described above, and is particularly advantageous in a power grid wherein dynamic reconfiguration of the power grid into different stand-alone sub-grids may be undertaken.

In one implementation, component identification within a power grid 700 includes determining whether to start the process to identify power grid connections 705. If “no”, then processing may wait a predefined time interval before again ascertaining whether to start the process. In one example, the component identification processing disclosed herein may be implemented periodically, or may be responsive to a noted configuration change to the power grid, such as a dynamic reconfiguration of the power grid to facilitate energy-efficient supply of needed power within the power grid.

Continuing with FIG. 7A, once the identification process is begun, processing loops through the power-consuming (or load) components in the grid 710. Note that this is one embodiment only of the concepts disclosed herein. In other embodiments, processing could loop through all components of the power grid, including supply and distribution components, such as described above. In the depicted embodiment of FIGS. 7A & 7B, it is assumed that the load components send the power-connected beacon, and the supply components attempt to detect the beacon. In another example, a non-functioning or non-operating power supply (source) could, for instance, be considered a load, and initiate a beacon as described herein. Thus, looping through the power-consuming or load components includes sending a request to a next power beacon transmitter to automatically broadcast that load component's power-connected beacon onto the energized power line of the power grid 715. At the same time, the controller instructs the power beacon detectors, for instance, associated with the power supply components, to monitor for a next beacon broadcast 720. The power beacon transmitter on the specified load component transmits its power-connected beacon 725, and the detectors, for instance, associated with the power supply components, ascertain whether the transmitted power-connected beacon have been received.

Continuing with FIG. 7B, processing, for instance, via the external controller, loops through the power supply components of the power grid 730 to determine which components detected the transmitted power-connected beacon. An inquiry is sent to a next power beacon detector 735 to determine whether that power beacon detector detected the issued power-connected beacon 740. If “yes”, then the information is stored that that load component is electrically connected via the energized power line to the associated power supply component 745. Processing next determines whether all power supply components (or more generally, all power beacon detectors) have been considered 750. If “no”, then processing loops back to send an inquiry to a next power beacon detector in the power grid to determine whether that detector received the superimposed power-connected beacon. Once all power beacon detectors (e.g., associated with the power supply components) have been considered, processing determines whether all load components (in one embodiment) have been considered 755. If “no”, then processing loops back to send a request to a next load component of the power grid to broadcast a power-connected beacon identifying, at least in part, the one component in the power grid 715 (FIG. 7A). Once all load components (or more generally, all power beacon transmitters) have been considered, the power grid configuration has been identified, and may be recorded, reported, etc., as desired 760 (FIG. 7B).

Those skilled in the art will note from the above description that provided herein is a facility for automated identification of components connected within a power grid, or sub-grid thereof. Automated power management requires the configuration of electrical connections between equipment to be identified. This is problematic in a dynamically changing power grid, such as described above. Disclosed herein is the utilization of a power beacon, comprising, for instance, a series of electrical pulses, in combination with a separate communication software facility working in coordination. The power beacon approach disclosed herein utilizes, for instance, a pulse width modulation process to produce a unique electronic pulse (or signature) that is transmitted over an AC power line, as directed by the communication software facility. In this manner, send and receive host mechanisms associated with the components of the power grid may automatically identify connections within a dynamically changing power grid or sub-grid.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embedded thereon.

Any combination of one or more computer readable medium(s) may be utilized. The computer readable medium may be a computer readable storage medium. A computer readable storage medium may be, for example, but not limited to, an electronic, magnetic, optical, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

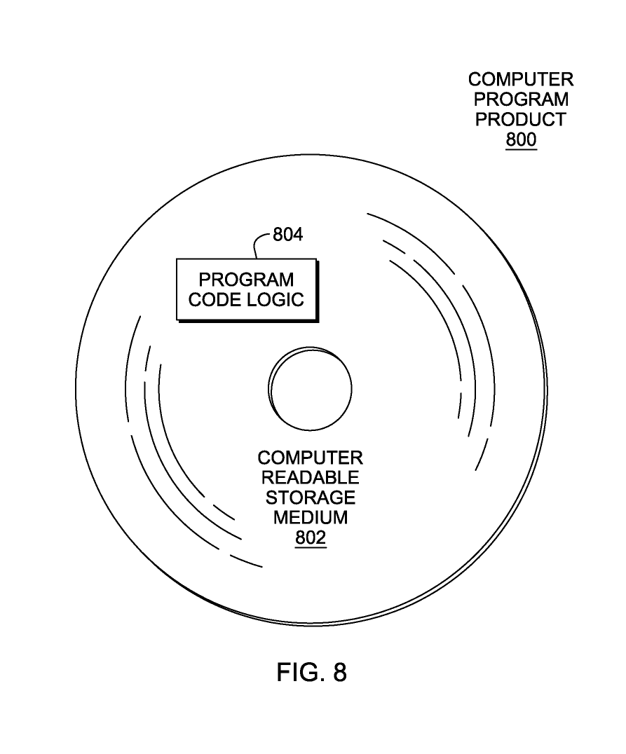

Referring now to FIG. 8, in one example, a computer program product 800 includes, for instance, one or more computer readable media 810 to store computer readable program code means or logic 820 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A method comprising:
facilitating automated identification of components connected via a power grid, the facilitating comprising:
obtaining by one component of the power grid a request to broadcast a power-connected beacon identifying, at least in part, the one component of the power grid; and
automatically broadcasting by the one component the power-connected beacon into the power grid, the automatically broadcasting comprising superimposing the power-connected beacon onto an energized power line of the power grid to signal that the one component is electrically connected to at least a portion of the power grid.

2. The method of claim 1, wherein the power grid comprises at least one stand-alone sub-grid, each stand-alone sub-grid comprising at least one power supply component and at least one load component, the one component being one component of the at least one power supply component and the one load component of one stand-alone sub-grid of the at least one stand-alone sub-grid of the power grid.

3. The method of claim 2, wherein the obtaining is subsequent to a reconfiguration of the power grid, wherein one or more stand-alone sub-grids of the at least one stand-alone sub-grid of the power grid are modified by the reconfiguration.

4. The method of claim 3, wherein the reconfiguration of the power grid is a dynamic reconfiguration of the power grid, wherein the one or more stand-alone sub-grids of the at least one stand-alone sub-grid of the power grid are automatically modified without interrupting power to the power grid, and without shedding load components from the power grid.

5. The method of claim 2, wherein the one component is a load component of the at least one load component of the one stand-alone sub-grid, and wherein the method further comprises, prior to the automatically broadcasting, obtaining by the at least one power supply component of the one stand-alone sub-grid an indication of an anticipated power-connected beacon broadcast on the energized power line of the power grid, and wherein the indication facilitates detection by the at least one power supply component of the power-connected beacon broadcast by the load component of the one stand-alone sub-grid.

6. The method of claim 2, wherein the one component is a load component of the at least one load component of the one stand-alone sub-grid, and the obtaining comprises receiving by the load component the request from a controller associated with the power grid, and wherein the controller sequentially sends the request to broadcast the power-connected beacon to a plurality of load components coupled to the power grid, the plurality of load components comprising the at least one load component of the one stand-alone sub-grid.

7. The method of claim 6, wherein, prior to the automatically broadcasting, the controller further sends an indication of an anticipated power-connected beacon broadcast on the energized power line of the power grid to a plurality of power supply components coupled to the power grid, the plurality of power supply components comprising the at least one power supply component of the one stand-alone sub-grid.

8. The method of claim 6, wherein the controller is associated with the at least one power supply component of the one stand-alone sub-grid of the at least one stand-alone sub-grid of the power grid, and the controller sends the request subsequent to a dynamic reconfiguration of the power grid, wherein one or more stand-alone sub-grids of the at least one stand-alone sub-grid of the power grid are automatically modified.

9. The method of claim 6, further comprising inquiring, by the controller, whether the at least one power supply component of the one stand-alone sub-grid received the power-connected beacon superimposed onto the energized power line of the power grid by the load component, and based in part thereon, the controller automatically determines which components of the plurality of load components and a plurality of power supply components coupled to the power grid are electrically connected in the one stand-alone sub-grid.

10. The method of claim 1, wherein the power-connected beacon is automatically broadcasted by the one component of the power grid, responsive to obtaining by the one component the request to broadcast, and comprises a unique signal to the one component within the power grid, the unique signal identifying at least one attribute of the one component of the power grid.

11. The method of claim 1, wherein the power-connected beacon comprises a distinct pattern of electrical pulses, and wherein the automatically broadcasting comprises automatically superimposing the distinct pattern of electrical pulses onto the energized power line for broadcast from the one component of the power grid as the power-connected beacon of that one component.

12. A system comprising:
at least one memory; and
at least one processor in communications with the at least one memory, wherein the system is configured to perform a method, the method comprising:
facilitating automated identification of components connected via a power grid, the facilitating comprising:
obtaining by one component of the power grid a request to broadcast a power-connected beacon identifying, at least in part, the one component of the power grid; and
automatically broadcasting by the one component the power-connected beacon into the power grid, the automatically broadcasting comprising superimposing the power-connected beacon onto an energized power line of the power grid to signal that the one component is electrically connected to at least a portion of the power grid.

13. The system of claim 12, wherein the power grid comprises at least one stand-alone sub-grid, each stand-alone sub-grid comprising at least one power supply component and at least one load component, the one component being one component of the at least one power supply component and the one load component of one stand-alone sub-grid of the at least one stand-alone sub-grid of the power grid.

14. The system of claim 13, wherein the one component is a load component of the at least one load component of the one stand-alone sub-grid, and wherein the method further comprises, prior to the automatically broadcasting, obtaining by the at least one power supply component of the one stand-alone sub-grid an indication of an anticipated power-connected beacon broadcast on the energized power line of the power grid, and wherein the indication facilitates detection by the at least one power supply component of the power-connected beacon broadcast by the load component of the one stand-alone sub-grid.

15. The system of claim 13, wherein the one component is a load component of the at least one load component of the one stand-alone sub-grid, and the obtaining comprises receiving by the load component the request from a controller associated with the power grid, and wherein the controller sequentially sends the request to broadcast the power-connected beacon to a plurality of load components coupled to the power grid, the plurality of load components comprising the at least one load component of the one stand-alone sub-grid.

16. The system of claim 15, wherein, prior to the automatically broadcasting, the controller further sends an indication of an anticipated power-connected beacon broadcast on the energized power line of the power grid to a plurality of power supply components coupled to the power grid, the plurality of power supply components comprising the at least one power supply component of the one stand-alone sub-grid.

17. The system of claim 15, further comprising inquiring, by the controller, whether the at least one power supply component of the one stand-alone sub-grid received the power-connected beacon superimposed onto the energized power line of the power grid by the load component, and based in part thereon, the controller automatically determines which components of the plurality of load components and a plurality of power supply components coupled to the power grid are electrically connected in the one stand-alone sub-grid.

18. A computer program product comprising:
a storage medium readable by a processing circuit and storing instructions for execution by the processing circuit for performing a method comprising:
facilitating automated identification of components connected via a power grid, the facilitating comprising:
obtaining by one component of the power grid a request to broadcast a power-connected beacon identifying, at least in part, the one component of the power grid; and
automatically broadcasting by the one component the power-connected beacon into the power grid, the automatically broadcasting comprising superimposing the power-connected beacon onto an energized power line of the power grid to signal that the one component is electrically connected to at least a portion of the power grid.

19. The computer program product of claim 18, wherein the power grid comprises at least one stand-alone sub-grid, each stand-alone sub-grid comprising at least one power supply component and at least one load component, the one component being one component of the at least one power supply component and the one load component of one stand-alone sub-grid of the at least one stand-alone sub-grid of the power grid.

20. The computer program product of claim 19, wherein the one component is a load component of the at least one load component of the one stand-alone sub-grid, and wherein the method further comprises, prior to the automatically broadcasting, obtaining by the at least one power supply component of the one stand-alone sub-grid an indication of an anticipated power-connected beacon broadcast on the energized power line of the power grid, and wherein the indication facilitates detection by the at least one power supply component of the power-connected beacon broadcast by the load component of the one stand-alone sub-grid.
